(19) United States
(12) Patent Application Publication
(10) Pub. No.: US 2008/0287294 A1
(43) Pub. Date: Nov. 20, 2008

(54) Method of Mollusc Control

(75) Inventors: Martin Weiss, Basel (CH); Franz Brandl, Basel (CH)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 11/911,577

(22) PCT Filed: Apr. 6, 2006
(86) PCT No.: PCT/EP2006/003134

§ 371 Date: Oct. 15, 2007

(30) Foreign Application Priority Data
Apr. 8, 2005 (EP) 05007712.2

(51) Int. Cl. A01N 25/26; A01N 43/40; A01N 43/24; A01C 1/06; A01N 65/00

(52) U.S. Cl. 504/100; 514/341; 514/66; 514/450; 514/28; 514/229.2

(57) ABSTRACT

A method of controlling mollusc damage to plants in horticulture or agriculture comprises treating the plant's propagation material with a combination comprising (I) one or more of (i) one or more of a neonicotinoid, (ii) one or more of a pyrethroid, (iii) one or more of a macrolide, and (iv) one or more of a defined bisamide compound, and (II) one or more of metaldehyde, methiocarb, thiodicarb, cinnamaldehyde and 3,5, dimethoxycinnamic acid, and optionally one or more customary formulation auxiliaries.

The present invention relates to a method for improving the growing characteristics of a plant, in particular by protecting the plant propagation material of the plant against damage by molluscs, which method comprises a defined treatment of the plant propagation material; a plant propagation material so treated; and a composition for such treatment.

Molluscs are serious pests, especially of cereals, such as wheat, and oil seed rape. The molluscs consume the seeds, seed growing points, and seedlings and thereby reduce the plant stand and yield of the crop.

Molluscs, such as slugs and snails, in horticulture and agriculture are a massively increasing problem. They can cause severe plant damage by feeding, and can also bring about undesirable soiling by slug and snail mucus and faeces. Changes in the management of crops (such as minimum tillage, direct drilling, and high organic matter build up in the soil) have led to increased population densities of slugs and snails and more severe damage on crops. The obligation to dispense with burning stubble fields—which is based on an ecological approach—and to manage the straw through other ways suggests that the existing mollusc problems, especially slug problems, are being made worse. Slugs feed vigorously above and below the surface on seeds, growing points, shoots and roots along with other organic matter they can find.

Current chemical control measures (bait pellets) often do not give adequate protection to plants, and pose an environmental hazard to mammals, and can often not be applied in a timely manner due to weather conditions and crop stand. In addition, at very early growing stages and when fields are dry, the molluscs do not come above ground which means baits are not effective, and crops are damaged.

There is, therefore, a demand for an effective management of this nuisance in horticulture and agriculture.

It has been found that treating plant propagation material before it is sown or planted with a combination of defined active ingredients provides surprisingly effective management against molluscs, and an increase in crop stand.

Accordingly, in a first aspect the present invention provides a method of improving the growing characteristics of a plant, which method comprises treating a propagation material of the plant with a combination comprising (I) one or more of (i) one or more of a neonicotinoid, (ii) one or more of a pyrethroid, (iii) one or more of a macrolide, and (iv) one or more of a defined bisamide compound, and (II) one or more of metaldehyde, cinnamaldehyde and 3,5, dimethoxycinnamic acid, and optionally one or more customary formulation auxiliaries.

In a second aspect the present invention provides a plant propagation material treated with the combination defined in the first aspect.

In a third aspect the present invention provides a composition comprising the combination defined in the first aspect.

In an embodiment of the third aspect, a plant propagation material, preferably seed, more preferably a mollusicidal seed, treatment composition is made available.

The present invention is believed to prevent damage to the plant propagation material and plant organs that grow at later point in time by molluscs, and thus improve the growth characteristics of the plant through improved control of such molluscs. Accordingly, in a further aspect the present invention provides a method of protecting plant propagation material and plant organs that grow at a later point in time against damage by molluscs, which method comprises treating the propagation material with the combination comprising (I) one or more of (i) one or more of a neonicotinoid, (ii) one or more of a pyrethroid, (iii) one or more of a macrolide, and (iv) one or more of a defined bisamide compound, and (II) one or more of metaldehyde, methiocarb, thiodicarb, cinnamaldehyde and 3,5, dimethoxycinnamic acid, and optionally one or more customary formulation auxiliaries.

Also, the present invention provide a method of reducing the damage caused by molluscs to plant propagation material and plant organs that grow at a later point in time, which method comprises treating the propagation material with the combination defined in the first aspect. Therefore, the present invention also makes available a method of controlling mollusc damage to plants in horticulture or agriculture comprises treating the plant's propagation material with a combination comprising (I) one or more of (i) one or more of a neonicotinoid, (ii) one or more of a pyrethroid, (iii) one or more of a macrolide, and (iv) one or more of a defined bisamide compound, and (II) one or more of metaldehyde, methiocarb, thiodicarb, cinnamaldehyde and 3,5, dimethoxycinnamic acid, and optionally one or more customary formulation auxiliaries.

The combinations of the invention are preventatively and/or curatively valuable active ingredients with a very favourable biocidal spectrum in the field of mollusc control, even at low use concentrations, and are well tolerated by warm blooded species, fish and plants. The combinations of the invention make it possible to treat seeds and other plant propagation materials with lower amounts of acutely toxic biocides than is known from the prior art.

The combinations of the invention are active against all or individual developmental stages of normally sensitive, but also resistant, molluscs. Using the combination, it is possible to control, i.e., contain or destroy, mollusc damage in particular on plants, mainly on useful plants and ornamentals in agriculture, in horticulture and in forests.

The molluscicidal action of the combinations of the invention according to the invention correspond to reduction of the damage caused by molluscs to plant propagation material and plant organs that grow at a later point in time and may manifest (i) directly, i.e., in destruction of the molluscs, either immediately or only after some time has elapsed, or indirectly, for example in a reduced oviposition and/or hatching rate, the good action corresponding to a destruction rate (mortality) of at least 50 to 60%, or (ii) through repellancy of the molluscs, for example, by a reduction in the seed hollowing, and any signs of changes in the mollusc behaviour, such as paralysis, reduced movement, swellings or deformation, or (iii) through a combination of (i) and (ii).

The combinations of the invention demonstrate synergistically enhanced action resulting in, for example, reduced damage to the plant by molluscs, lower rates of application of the individual active ingredients for such control, a longer duration of action and all together higher crop yields. The increase in advantageous properties achieved with the combinations of the invention are significantly greater than the activity to be expected by the individual components. In particular, it has now been found, surprisingly, that, for example, the activity of the treatment of the combinations of the invention on the plant propagation material, compared with the activity of the individual active ingredients, are not merely additive, as may essentially be expected, but that a synergistic effect exists. This effect can be calculated according to the Colby formula.

The term “synergistic” is not, however, in any way limited in this context to the molluscicidal activity, but refers equally to other advantageous properties. Examples of such advantageous properties that may be mentioned are: a broadening of the spectrum of pesticidal activity to other pests, for example to resistant strains; a reduction in the rate of application of the active ingredients; adequate control of the pests with the aid of the combinatons, even at a rate of application at which the individual active ingredients are totally ineffective; advantageous behavior during formulating and/or upon application, for example upon grinding, sieving, emulsifying, dissolving or dispersing; increased storage stability; improved stability to light; more advantageous degradability; improved toxicological and/or ecotoxicological behavior; improved crop characteristics including: emergence, crop yields, more developed root system, tillering increase, increase in plant height, bigger leaf blade, less dead basal leaves, stronger tillers, greener leaf color, less fertilizers needed, less seeds needed, more productive tillers, earlier flowering, early grain maturity, less plant verse (lodging), increased shoot growth, improved plant vigor, and early germination; or any other advantages familiar to a person skilled in the art.

The improvement in the growing (or growth) characteristics of a plant can manifest in a number of different ways, but ultimately it results in a better product of the plant. It can, for example, manifest in improving the yield and/or vigour of the plant or quality of the harvested product from the plant.

As used herein the phrase “improving the yield” of a plant relates to an increase in the yield of a product of the plant by a measurable amount over the yield of the same product of the plant produced under the same conditions, but without the application of the subject method. It is preferred that the yield be increased by at least about 0.5%, more preferred that the increase be at least about 1%, even more preferred is about 2%, and yet more preferred is about 4%, or more. Yield can be expressed in terms of an amount by weight or volume of a product of the plant on some basis. The basis can be expressed in terms of time, growing area, weight of plants produced, amount of a raw material used, or the like.

As used herein the phrase “improving the vigour” of a plant relates to an increase or improvement of the vigour rating, or the stand (the number of plants per unit of area), or the plant height, or the plant canopy, or the visual appearance (such as greener leaf colour), or the root rating, or emergence, or protein content, or increased tillering, or bigger leaf blade, or less dead basal leaves, or stronger tillers, or less fertilizer needed, or less seeds needed, or more productive tillers, or earlier flowering, or early grain maturity, or less plant verse (lodging), or increased shoot growth, or earlier germination, or any combination of these factors, or any other advantages familiar to a person skilled in the art, by a measurable or noticeable amount over the same factor of the plant produced under the same conditions, but without the application of the subject method.

When it is said that a method is capable of “improving the yield and/or vigour” of a plant, the present method results in an increase in either the yield, as described above, or the vigor of the plant, as described above, or both the yield and the vigor of the plant.

The combinations of the invention can also be used to treat stored products for protection against molluscs.

A single pesticide may have activity in more than area of pest control, for example, a pesticide may have fungicide, insecticide and nematicide activity. Specifically, aldicarb is known for insecticide, acaricide and nematicide activity, while metam is known for insecticide, herbicide, fungicide and nematicide activity, and thiabendazole and captan can provide nematicide and fungicide activity.

The combinations of the invention are found to demonstrate unexpected molluscicidal action, especially against slugs.

The molluscs include, for example, Ampullariidae; Arion (A. ater, A. circumscriptus, A. hortensis, A. rufus); Bradybaenidae (Bradybaena fruticum); Cepaea (C. hortensis, C. Nemoralis); ochlodina; Deroceras (D. agrestis, D. empiricorum, D. laeve, D. reticulatum); Discus (D. rotundatus); Euomphalia; Galba (G. trunculata); Helicelia (H. itala, H. obvia); Helicidae Helicigona arbustorum); Helicodiscus; Helix (H. aperta); Limax (L. cinereoniger, L. flavus, L. marginatus, L. maximus, L. tenellus); Lymnaea; Milax (M. gagates, M. marginatus, M. sowerbyi); Opeas; Pomacea (P. canaticulata); Vallonia and Zanitoides. The combinations according to the present invention are particularly effective against Deroceras, such as Deroceras reticulatum.

Even distribution of the active ingredients and adherence thereof to the propagation material is desired during treatment of the propagation material, for example, a seed. The treatment could vary from a thin film (such as a dressing) of the formulation containing the active ingredient(s) on a plant propagation material, such as a seed, where the original size and/or shape are recognizable to a thick film (such as a coating or pelleting with many layers of different materials (such as carriers, for example, clays; different formulations, such as of other active ingredients; polymers; and colourants) where the original shape and/or size of the seed is no longer recognisable.

Accordingly, in the second aspect, the active ingredients are adhered to the propagation material, such a seed. The treated propagation material, consequently, demonstrates resistance to molluscs and pests as a result of the treatment.

The combination of (I) and (II) can be treated or applied simultaneously, or sequentially, in any order, on to the propagation material. Similarly if there is more than one active ingredient in (I) or (II), then those active ingredients can be treated simultaneously, or sequentially, in any order, on to the propagation material.

Methods for applying pesticides on to propagation material, especially seeds, are known in the art, and include dressing, coating, pelleting and soaking application methods of the propagation material.

The term “plant propagation material” is understood to denote all the generative parts of the plant, such as seeds, which can be used for the multiplication of the latter and vegetative plant material such as cuttings and tubers (for example, potatoes). There may be mentioned, e.g., the seeds (in the strict sense), roots, fruits, tubers, bulbs, rhizomes, parts of plants. Germinated plants and young plants, which are to be transplanted after germination or after emergence from the soil, may also be mentioned. These young plants may be protected before transplantation by a total or partial treatment by immersion.

Preferably, the propagation material is a seed.

Although it is believed that the present method can be applied to a seed in any physiological state, it is preferred that the seed be in a sufficiently durable state that it incurs no damage during the treatment process. Typically, the seed would be a seed that had been harvested from the field; removed from the plant; and separated from any cob, stalk, outer husk, and surrounding pulp or other non-seed plant material. The seed would preferably also be biologically stable to the extent that the treatment would cause no biological damage to the seed. It is believed that the treatment can be applied to the seed at any time between harvest of the seed and sowing of the seed or during the sowing process (seed directed applications). The seed may also be primed either before or after the treatment.

The seed treatment occurs to an unsown seed, and the term “unsown seed” is meant to include seed at any period between the harvest of the seed and the sowing of the seed in the ground for the purpose of germination and growth of the plant.

Treatment to an unsown seed is not meant to include those practices in which the pesticide is applied to the soil but would include any application practice that would target the seed during the planting process.

Preferably, the treatment occurs before sowing of the seed so that the sown seed has been pre-treated with (I) and (II). In particular, seed coating or seed pelleting are preferred in the treatment of the combinations according to the invention.

The weight ratio of (I) to (II) and amount used on the propagation material varies according to specific active ingredient (e.g., abamectin is generally applied at a lower rate than thiamethoxam), type of propagation material (e.g., seed or tuber) and plant (for example, wheat seeds generally have less active ingredients adhered thereto than oil seed rape seeds based on equivalent weight of seeds) and is such that the combinations are an effective amount to provide the desired molluscicidal action and can be determined by biology trials.

The weight ratio of (I) to (II) is generally selected as to give the desired, for example synergistic, action. In general, the weight ratio I:II (based on binary mixtures, such as thiamethoxam and metaldehyde) is from 5:1 to 1:5, preferably from 2.5:1 to 1:2.5, more preferably, 1:1.5 to 1.5:1.

The application rates can, therefore, range from 6 g to 250 kg of (I) and (II) per 100 kg of seeds. Generally, the combined application rate of (I) and (II) for cereal seeds range from 23 g to 740 g, preferably 50 g to 600 g, per 100 kg of seeds; and the combined application rate of (I) and (II) for oil seed rape seeds can range from 700 g to 25 kg, preferably 1.5 kg to 20 kg, per 100 kg of seeds.

In an embodiment of each aspect of the invention, the combination is, as active ingredients, (I) and (II).

In a further embodiment, active ingredient (I) is one or more of a neonicotinoid, or (ii) one or more of a pyrethroid, or (iii) one or more of a macrolide, or (iv) one or more of a defined bisamide compound,

In an embodiment, independent of other embodiments and aspects, (i) the neonicotinoid is from one or more of acetamiprid, clothianidin, dinotefuran, imidacloprid, nitenpyram, thiacloprid, thiamethoxam. Preferred neonicotinoid insecticides include clothianidin, thiacloprid imidacloprid and thiamethoxam. Particularly preferred neonicotinoid insecticides include thiamethoxam and imidacloprid.

In an embodiment, independent of other embodiments and aspects, (ii) the pyrethroid is from one or more of alpha-cypermethrin, beta-cyfluthrin, beta-cypermethrin, bifenthrin, bioallethrin, bioresmethrin, cycloprothrin, cyfluthrin, cyhalothrin, cypermethrin, cyphenothrin, deltamethrin, empenthrin, esfenvalerate, fenpropathrin, fenvalerate, flucythrinate, flumethrin, gamma-cyhalothrin, imiprothrin, lambda-cyhalothrin, methothrin, metofluthrin, permethrin, phenothrin, prallethrin, resmethrin, tau-fluvalinate, tefluthrin, tetramethrin, theta-cypermethrin, tralomethrin, transfluthrin, and zeta-cypermethrin. Preferred pyrethroid insecticides include tefluthrin and lambda cyhalothrin.

In an embodiment, independent of other embodiments and aspects, (iii) the macrolide is selected from abamectin, emamectin, spinosad, doramectin, eprinomectin, ivermectin, selamectin, and substituted milbemectins, such a compound of formula

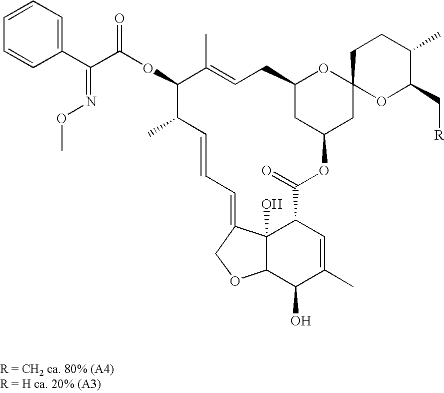

Preferably the macrolide is selected from emamectin, abamectin, spinosad, and a compound of formula

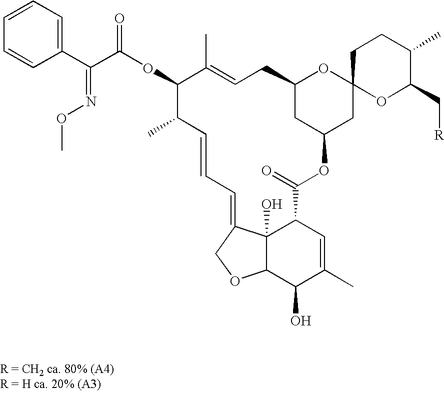

In an embodiment, independent of other embodiments and aspects, (iv) the bisamide is one or more of flubendiamide (3-iodo-N′-(2-mesyl-1,1-dimethylethyl)-N-{4-[1,2,2,2-tetrafluoro-1-(trifluoromethyl)ethyl]-o-tolyl}phthalamide) and a compound of formula A-1 below.

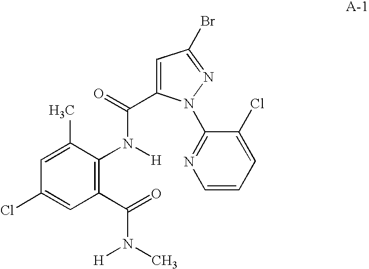

In another embodiment, a combination according to the invention comprises, as active ingredient, a neonicotinoid and metaldehyde; preferably thiamethoxam or imidacloprid or clothianidin or thiacloprid and metaldehyde.

Alternatively, a combination according to the invention comprises, as active ingredient, a macrolide and metaldehyde; preferably abamectin and metaldehyde.

In a preferred embodiment, a combination according to the present invention comprises a neonicotinoid, a pyrethroid, abamectin, and metaldehyde; preferably thiamethoxam, tefluthrin, abamectin and metaldehyde.

Further, the growing characteristics of a plant can be further improved by incorporating in the treatment on the propagation material one or more pesticides (e.g., a fungicide, insecticide or nematicide), which can provide control of pests, such as diseases, nematodes and insects.

A single pesticide may have activity in more than area of pest control, for example, a pesticide may have fungicide, insecticide and nematicide activity. Specifically, aldicarb is known for insecticide, acaricide and nematicide activity, while metam is known for insecticide, herbicide, fungicide and nematicide activity.

Accordingly, pesticides (active ingredients) indicated in (I) and (II) above can also be used as co-pesticides.

Suitable examples of other pesticides to use with combination (I) and (II) include triazole derivatives, strobilurins, carbamate (including thiocarbamate), benzimidazoles (thiabendazole), N-trihalomethylthio compounds (captan), substituted benzenes, carboxamides (especially Carboxanilides), phenylamides and phenylpyrroles, and mixtures thereof; and carbamates.

Specifc examples are acephate (2), azinphos-methyl (45), carbaryl (115), carboxin (120), carbofuran (118), carbosulfan (119), chlorpyrifos (145), cyromazine (209), dimethoate (262), endosulfan (294), fipronil (354), furathiocarb (412), gamma-HCH (430), isofenphos, omethoate (594), azoxystrobin (47), pyraclostrobin (690), benomyl (62), benalaxyl (56), bitertanol (84), captan (114), carbendazim (116), carboxin (120), chlorothalonil (142), copper salts (such as copper sulfate (172), cuprous oxide (181), Bordeaux mixture (87), copper hydroxide (169), copper sulfate (tribasic) (173), copper oxychloride (171) and copper octanoate (170)), cymoxanil (200), cyproconazole (207), cyprodinil (208), difenoconazole (247), dimoxystrobin, diniconazole (267), ethirimol, famoxadone (322), fenoxanil (338), fenamidone (325), fenhexamid (334), fenpiclonil (341), fluazinam (363), fluquinconazole (385), flutolanil (396), fosetyl-aluminium (407), fuberidazole (409), guazatine (422), hexaconazole (435), hymexazol (447), imazalil (449), iprodione (470), mancozeb (496), maneb (497), metalaxyl (516), metalaxyl-M (517), metconazole (525), myclobutanil (564), nuarimol (587), silthiofam (729), oxadixyl (601), oxine-copper (605), oxolinic acid (606), pencycuron (620), prochloraz (659), procymidone (660), pyrimethanil (705), propiconazole (675), pyraclostrobin (690), pyroquilon (710), quintozene (716), tebuconazole (761), tetraconazole (778), thiabendazole (790), thiophanate-methyl (802), thiram (804), triadimenol (815), triazoxide (821), triticonazole (842), trifloxystrobin (832), picoxystrobin (647) and ipconazole (468), and 3-Difluoromethyl-1-methyl-1 Hpyrazole-4-carboxylic acid (2-bicyclopropyl-2-yl-phenyl)-amide.

In an embodiment one or more of metalaxyl-M (517), fipronil (354), difenoconazole (247), azoxystrobin (47), fludioxonil, silthiofam (729), thiabendazole (790) and myclobutanil (564) is preferred.

Especially preferred mixing partners are metalaxyl (516), metalaxyl-M (517), difenoconazole (247), fludioxonil, azoxystrobin (47), silthiofam (729), myclobutanil and thiabendazole (790).

It has been found that a combination of (a) metalaldehyde and thiamethoxam, or (b) metalaldehyde and imidacloprid, or (c) metalaldehyde and chlothianidin, demonstrates particularly good activity.

The compounds (I) or (II) may be used either in pure form, i.e., as a solid active ingredient, for example, in a specific particle size, or preferably together with at least one of the auxiliary (also known as adjuvants) customary in formulation technology, such as extenders, e.g., solvents or solid carriers, or surface-active compounds (surfactants), in the form of a formulation, in the present invention. Generally, the compounds (I) and (II) are in the form of a formulation composition with one or more of customary formulation auxiliaries.

Therefore, the combination of compounds (I) and (II) are normally used in the form of formulations. The compounds (I) and (II) can be applied or treated to the plant propagation material either simultaneously or in succession at short interval. In a preferred embodiment, (I) and (II) are applied simultaneously.

In the event compounds (I) and (II) are applied simultaneously in the present invention, they may be applied as a composition containing (I) and (II), in which case each of (I) and (II) can be obtained from a separate formulation source and mixed together (known as a tank-mix, ready-to-apply, spray broth, or slurry), optionally with other pesticides, or (I) and (II) can be obtained as single formulation mixture source (known as a pre-mix, concentrate, formulated compound (or product)), and optionally mixed together with other pesticides.

In an embodiment, the combination of the present invention is applied as a composition. Accordingly, the present invention is a composition comprising, as active ingredients, (I) and (II), and optionally other pesticides, and optionally one or more customary formulation auxiliaries; which may be in the form of a tank-mix or pre-mix composition.

The pesticides can be applied to the seeds using conventional treating techniques and machines, such as fluidized bed techniques, the roller mill method, rotostatic seed treaters, and drum coaters. Other methods, such as spouted beds may also be useful. The seeds may be presized before coating. After coating, the seeds are typically dried and then transferred to a sizing machine for sizing. Such procedures are known in the art.

Whereas commercial products will preferably be formulated as concentrates (known as a pre-mix composition (or concentrate, formulated compound (or product)), the end user will normally employ dilute formulations (known as a tank mix composition (or ready-to-apply, spray broth, or slurry)), optionally also containing one or more other pesticide pre-mix formulations for treatment of the propagation material, but can also use appropriately formulated pre-mix compositions.

The pesticide formulation for the treatment can take a variety of forms including, suspensions, emulsions, solutions or dusts, optionally with the use of polymeric carriers or stickers.

The formulation (pre-mix or tank-mix), therefore, can comprise as well as (I) and (II), at least one of the auxiliary (also known as adjuvants) customary in formulation technology, such as extenders, e.g., solvents (e.g., water) or solid carriers, or surface-active compounds (surfactants), and optionally other pesticides. Accordingly, a composition of the third aspect generally also comprises one or more auxiliary customary in formulation technology.

Examples of seed treatment pre-mix formulations types are

WS: wettable powders for seed treatment slurry
LS: solution for seed treatment
ES: emulsions for seed treatment
FS: suspension concentrate for seed treatment
WG: water dispersible granules, and
CS: aqueous capsule suspension.

Examples of formulation types suitable for tank-mix compositions are solutions, dilute emulsions, suspensions, or a mixture thereof, and dusts.

The tank-mix compositions are generally prepared by diluting with a solvent (for example, water) the one or more pre-mix compositions containing different pesticides, and optionally further auxiliaries. Generally, an aqueous tank-mix is preferred.

Normally, a tank-mix formulation for seed treatment application comprises 0.25 to 80%, especially 1 to 75%, of a pesticide, and 99.75 to 20%, especially 99 to 25%, of a solid or liquid auxiliaries (including, for example, a solvent such as water), where the auxiliaries can be a surfactant in an amount of 0 to 40%, especially 0.5 to 30%, based on the tank-mix formulation.

Typically, a pre-mix formulation for seed treatment application comprises 0.5 to 99.9%, especially 1 to 95%, of a pesticide, and 99.5 to 0.1%, especially 99 to 5%, of a solid or liquid adjuvant (including, for example, a solvent such as water), where the auxiliaries can be a surfactant in an amount of 0 to 50%, especially 0.5 to 40%, based on the pre-mix formulation. Preferred seed treatment pre-mix formulations are aqueous suspension concentrates.

The Examples, which follow serve to illustrate the suitable formulations.

### FORMULATION EXAMPLES

| Wettable powders | a) | b) | c) |
|---|---|---|---|
| active ingredient | 25% | 50% | 75% |
| sodium lignosulfonate | 5% | 5% | — |
| sodium lauryl sulfate | 3% | — | 5% |
| sodium diisobutylnaphthalenesulfonate | — | 6% | 10% |
| phenol polyethylene glycol ether | — | 2% | — |
| (7-8 mol of ethylene oxide) | | | |
| highly dispersed silicic acid | 5% | 10% | 10% |
| Kaolin | 62% | 27% | — |

The active ingredient is thoroughly mixed with the adjuvants and the mixture is thoroughly ground in a suitable mill, affording wettable powders which can be diluted with water to give suspensions of the desired concentration.

| Dusts | a) | b) | c) |
|---|---|---|---|
| active ingredient | 5% | 6% | 4% |
| Talcum | 95% | — | — |
| Kaolin | — | 94% | — |
| mineral filler | — | — | 96% |

Ready-for-use dusts are obtained by mixing the active ingredient with the carrier and grinding the mixture in a suitable mill. Such powders can be used for dry dressings for seed.

| Suspension concentrates | (a) | (b) |
|---|---|---|
| active ingredient | 5% | 30% |
| propylene glycol | 10% | 10% |
| Tristyrylphenol ethoxylates | 5% | 6% |
| sodium lignosulfonate | — | 10% |
| carboxymethylcellulose | — | 1% |
| silicone oil (in the form of a 75% emulsion in water) | 1% | 1% |
| Colour pigment | 5% | 5% |
| water | 74% | 37% |

The finely ground active ingredient is intimately mixed with the adjuvants, giving a suspension concentrate from which suspensions of any desired dilution can be obtained by dilution with water. Alternatively, a suspension of the active, ingredients and auxiliaries (including water) is wet milled with a bead-mill to achieve a stable formulation and with the appropriate treatment characteristics.

In an embodiment, the composition of the third aspect is in the form of an aqueous suspension, and, in the instance it is a pre-mix formulation, it is in the form of a suspension concentrate.

The treated plant propagation material of the present invention can be treated in the same manner as conventional plant propagation material.

The treated seeds can be stored, handled, sowed and tilled in the same manner as any other pesticide treated seed.

In an embodiment of the present invention, the action of the seed treatment molluscicide can be significantly improved and adapted to the given circumstances by the use of a molluscicide compounds used in agriculture, for example, by use of slug baits.

The present invention is especially suitable for agronomically important plants, which refers to a plant that is harvested or cultivated on a commercial scale.

Examples of such agronomic plants (or crops) are cereals, such as wheat, barley, rye, oats, rice, maize or sorghum; beet, such as sugar or fodder beet; fruit, for example pome fruit, stone fruit and soft fruit, such as apples, pears, plums, peaches, almonds, cherries or berries, for example strawberries, raspberries or blackberries; legumes, such as beans, lentils, peas or soya beans; oil crops such as oil seed rape, mustard, poppies, olives, sunflowers, coconuts, castor, cacao or peanuts; the marrow family, such as pumpkins, cucumbers or melons; fibre plants such as cotton, flax, hemp or jute; citrus fruits such as oranges, lemons, grapefruits or tangerines; vegetables such as spinach, lettuce, asparagus, cabbage species, carrots, onions, chillis, tomatoes, potatoes, or capsicums; the laurel family such as avocado, Cinnamonium or camphor; and tobacco, nuts, coffee, egg plants, sugar cane, tea, pepper, grapevines, hops, the banana family, latex plants and ornamentals.

Suitable target crops also include transgenic crop plants of the foregoing types. The transgenic crop plants used according to the invention are plants, or propagation material thereof, which are transformed by means of recombinant DNA technology in such a way that they are—for instance—capable of synthesizing selectively acting toxins as are known, for example, from toxin-producing invertebrates, especially of the phylum Arthropoda, as can be obtained from Bacillus thuringiensis strains; or as are known from plants, such as lectins; or in the alternative capable of expressing a herbicidal or fungicidal resistance. Examples of such toxins, or transgenic plants which are capable of synthesizing such toxins, have been disclosed, for example, in EP-A-0 374 753, WO 93/07278, WO 95/34656, EP-A-0 427 529 and EP-A-451 878 and are incorporated by reference in the present application.

The invention is especially suitable for wheat, barley, oil seed rape plants, sugar beets and vegetables.

In each aspect and embodiment of the invention, “consisting essentially” and inflections thereof are a preferred embodiment of “comprising” and its inflections, and “consisting of” and inflections thereof are a preferred embodiment of “consisting essentially of” and its inflections.

A description of the structure of the pesticides mentioned herein can be found in the e-Pesticide Manual, version 3.1, 13th Edition, Ed. CDC Tomlin, British Crop Protection Council, 2004-05.

The following Examples are given by way of illustration and not by way of limitation of the invention.

### Examples

### Example 1

Wheat seeds are sown to a depth of approximately 2 cm in plastic seed trays (55 cm length, 31 cm width, 5 cm high) with the soil flush with the top of the trays. 100 seeds are sown per tray, and three trays are placed in an arena. Trays are placed in an arena so that the top of the tray is flush with soil in the arena. The arena contains a mix of composting soil and top soil (compost:top soil in a 2:1 ratio) to a depth of approximately 5 cm. A 2 cm wide copper tape barrier is applied to inner wall of the arena to contain the slugs. Neffing to stop feeding on the seeds by birds covers the arenas. During dry weather arenas are watered regularly to ensure they do not dry out.

Each tray is sown with seeds by different treatment. Then 30 slugs (Deroceras reticulatum (Muller)−average weight range 400-600 mg) are added to each arena.

The combinations according to the present invention show good action compared to the individual active ingredients alone.

### Example 2

50 wheat seeds are sown in 0.2 m² tray on moist filter paper and kept under controlled conditions (17° C. and 90% humidity). Five slugs are introduced into each tray, a number equivalent to a “heavy infestation”. In terms of crop protection the wheat grains are examined for signs of seed hollowing and germination.

The combinations according to the present invention show good action compared to the individual active ingredients alone.

1. A method of controlling mollusc damage to plants in horticulture or agriculture comprises treating the plant's propagation material with a combination comprising (I) (i) thiamethoxam and/or imidacloprid or (iii) abamectin, and (II) metaldehyde, and optionally one or more customary formulation auxiliaries.

2. A method of improving the growing characteristics of a plant, which method comprises treating a propagation material of the plant with a combination comprising (I) one or more of (i) one or more of a neonicotinoid, (ii) one or more of a pyrethroid, (iii) one or more of a macrolide, and (iv) one or more of a bisamide compound selected from flubendiamide and a compound of formula 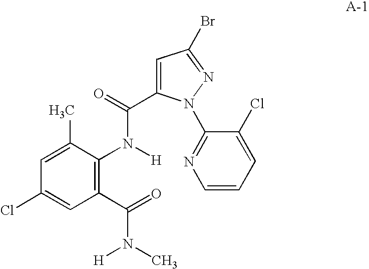
and (II) one or more of metaldehyde, cinnamaldehyde and 3,5, dimethoxycinnamic acid, and optionally one or more customary formulation auxiliaries.

3. The method according to claim 2 wherein the neonicotinoid is selected from thiamethoxam, thiacloprid, imidacloprid and clothianidin.

4. The method according to either claim 2 wherein the pyrethroid is selected from tefluthrin and lamda cyhalothrin.

5. The method according to claim 2 wherein the bisamide compound is a compound of formula

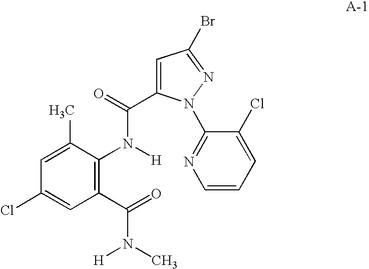

6. The method according to claim 2 wherein the macrolides is selected from emamectin, abamectin, spinosad, and a compound of formula

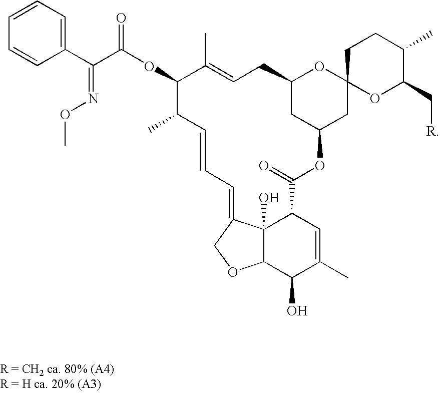

7. The method according to claim 2 wherein active ingredient (II) is metaldehyde.

8. The method according to claim 1 wherein the plant is selected from cereals, beet, fruit, legumes, oil crops, the marrow family, citrus fruits, vegetables, the laurel family, tobacco, nuts, coffee, egg plants, sugar cane, tea, pepper, grapevines, hops, the banana family, latex plants and ornamentals.

9. The method according to claim 1 wherein one or more further pesticides are also used in the treatment.

10. The method according to 9 wherein the pesticide is a fungicide, insecticide or nematicide.

11. The method according to claim 1 wherein the treatment protects the plant propagation material and plant organs that grow at a later point in time against damage by molluscs.

12. A plant propagation material treated with a combination as defined in claim 1.

13. A plant propagation material treatment composition comprising (I) and (II) as defined in claim 1, and optionally one or more customary formulation auxiliaries.

14. A method of protecting plant propagation material and plant organs that grow at a later point in time against damage by molluscs, which method comprises treating the propagation material with a combination comprising (I) one or more of (i) one or more of a neonicotinoid, (ii) one or more of a pyrethroid, (iii) one or more of a macrolide, and (iv) one or more of a defined bisamide compound, and (II) one or more of metaldehyde, methiocarb, thiodicarb, cinnamaldehyde and 3,5, dimethoxycinnamic acid, and optionally one or more customary formulation auxiliaries.

15. A method of controlling mollusc damage to plants in horticulture or agriculture comprises treating the plant's propagation material with a combination as defined in claim 14.
